(19) United States
(12) Patent Application Publication
(10) Pub. No.: US 2025/0336026 A1
(43) Pub. Date: Oct. 30, 2025

(54) GRAPHICS PROCESSING SYSTEMS

(71) Applicant: Arm Limited, Cambridge (GB)

(72) Inventors: Jakob Axel Fries, Lund (SE); Ole Henrik Jahren, Trondheim (NO); Wing-Tsi Henry Wong, Lund (SE); Olof Henrik Uhrenholt, Lund (SE); Muhammad Ali Shami, Lund (SE)

(73) Assignee: Arm Limited, Cambridge (GB)

(21) Appl. No.: 19/190,070

(22) Filed: Apr. 25, 2025

(30) Foreign Application Priority Data
Apr. 29, 2024 (GB) 2405981.8

(51) Int. Cl. G06T 1/60; G06T 1/20; G06T 9/00

(52) U.S. Cl. CPC G06T 1/60; G06T 1/20; G06T 9/00

(57) ABSTRACT

A tile-based graphics processor comprises a data encoder configured to perform block-based compression of uncompressed tile data to be written from a tile buffer to a memory system and an accumulation buffer that receives tile data from the tile buffer 303 and provides tile data to the data encoder for encoding. The data encoder is configured to encode compression units of uncompressed data having a particular size for storing in a memory system in a compressed format, and the accumulation buffer is configured to provide arrays of data that are equal to the particular size to the data encoder for encoding.

### BACKGROUND

The technology described herein relates to graphics processing systems, and in particular to systems for and methods of writing out compressed data to memory in tile-based graphics processing systems.

Graphics processing operations, which may be performed by a graphics processor (graphics processing unit (GPU)), typically process data in an uncompressed form. When such operations have produced a particular output (such as a tile for render output in a tile-based graphics processing system), the output data may then be written out to a (e.g. frame) buffer, for example in main memory, for storage for further processing (e.g. display of the frame).

In tile-based graphics processing, the two-dimensional graphics processing (render) output (i.e. the output of the rendering process, such as an output frame to be displayed) is generated (rendered) as a plurality of smaller area regions, usually referred to as “tiles”. The render output is typically divided (by area) into regularly-sized and shaped rendering tiles (they are usually e.g. squares or rectangles). The tiles are each rendered separately (e.g. one after another). The rendered tiles are then combined to provide the complete render output (e.g. frame for display).

To support such operation, a tile-based graphics processor will typically include a set of one or more tile buffers for storing tile data locally to the graphics processor while a tile is being rendered (generated). Then, once a given rendering tile has been completed for a render output, the rendering tile will be written out from the tile buffer to other storage, such as, for example, a (e.g. frame) buffer, for example in main memory.

Once all the tiles for a given render output have been written out to the (e.g. frame) buffer, then the render output can be used for further processing (e.g. provided to a display for display, or otherwise processed).

To reduce the amount of data that needs to be transferred to and stored in memory when performing tile-based graphics processing, the tile data may be stored in a compressed form in the memory.

The Applicants believe there remains scope for improvements to storing tile data in compressed form in tile-based graphics processing systems.

### BRIEF DESCRIPTION OF THE DRAWINGS

Embodiments of the technology described herein will now be described by way of example only and with reference to the accompanying drawings, in which:

FIG. 1 shows an exemplary graphics processing system in which the technology described herein may be implemented;

FIG. 2 shows an exemplary graphics processing pipeline;

FIGS. 3 and 4 show schematically a graphics processor that may be operated in accordance with the technology described herein;

FIG. 5 shows an encoder of the graphics processor of FIGS. 3 and 4 in more detail;

FIG. 6 shows an exemplary compression unit layout for an output data array to be compressed;

FIG. 7 shows the corresponding rendering tile layout for the output data array of FIG. 6;

FIG. 8 illustrates the potential mismatch between a rendering tile and compression units to be encoded;

FIG. 9 shows the writing of a tile to the accumulation buffer in an embodiment;

FIG. 10 shows the operation of the accumulation buffer when receiving tile data in an embodiment;

FIG. 11 shows the operation when a compression unit is evicted from the accumulation buffer in an embodiment; and

FIG. 12 shows the operation when the accumulation buffer needs more data for a compression unit to be written out in an embodiment

Like reference numerals are used for like features in the Figures, where appropriate.

### DETAILED DESCRIPTION

A first embodiment of the technology described herein comprises a graphics processing system comprising:
in an embodiment, a memory system; and
a graphics processor;
wherein the graphics processor comprises:
   processing circuits configured to execute a tile-based graphics processing pipeline to generate tiles of an output being generated;
   a tile buffer for storing tiles of an output being generated; and
   a write-out circuit for writing tiles of an output from the tile buffer towards a (the) memory system;
   the graphics processing system further comprising:
   a data encoder configured to perform block-based compression of uncompressed tile data to be written from the tile buffer to a (the) memory system; and
   an accumulation buffer intermediate the tile write-out circuit and the encoder; wherein:
   the tile write-out circuit is configured to provide tile data from the tile buffer to the accumulation buffer; and
   the accumulation buffer is configured to provide tile data to the data encoder for encoding; and
   the data encoder is configured to encode blocks of uncompressed data having a particular size for storing in a (the) memory system in a compressed format; and
   the accumulation buffer is configured to provide arrays of data that are equal to the particular size to the data encoder for encoding.

A second embodiment of the technology described herein comprises a method of operating a graphics processing system, the graphics processing system comprising:
in an embodiment, a memory system; and
a graphics processor operable to execute a tile-based graphics processing pipeline to generate tiles of an output being generated, the graphics processor comprising:
   a tile buffer for storing tiles of an output being generated; and
   a write-out circuit for writing tiles of an output from the tile buffer towards a (the) memory system;
   the graphics processing system further comprising:
   a data encoder configured to perform block-based compression of uncompressed tile data to be written from the tile buffer to a (the) memory system, the data encoder configured to encode blocks of uncompressed data having a particular size for storing in a (the) memory system in a compressed format; and
   an accumulation buffer intermediate the tile write-out circuit and the data encoder;
   the method comprising:
   the tile write-out circuit providing tile data from the tile buffer to the accumulation buffer;
   the accumulation buffer providing an array of tile data that is equal to the particular size to the data encoder for encoding; and
   the data encoder compressing the array of tile data that is equal to the particular size provided by the accumulation buffer to generate a compressed block of tile data, and writing the compressed block of tile data towards a (the) memory system.

The technology described herein relates to tile-based graphics processing systems, in which respective tiles of an output being generated are stored in a tile buffer as they are being generated, and then written from the tile buffer towards (to) a memory system for storage. Furthermore, in the technology described herein, tile data that is written out to the memory system is encoded using a block-based compression scheme before being stored in the memory system.

In the technology described herein, an accumulation buffer is provided intermediate (in the data path from) the write-out circuit that writes data out from the tile buffer and an encoder which performs the block-based compression before the data is written to the memory system.

The accumulation buffer receives data of (completed) tiles from the tile buffer, and outputs that data to the encoder (encoding process) as data arrays corresponding to the (uncompressed) data array size that the block-based compression scheme of the encoder uses. In other words, the accumulation buffer is configured to ensure that the encoder receives an appropriate “complete” block of data (a complete “compression unit”) for compressing and writing out to the memory system.

The Applicants have recognised in this regard that the data array (compression unit) size that a block-based compression scheme may use often may not match the configuration and/or size of tiles that are being generated by a tile-based graphics processing system, such that, for example, a given tile may comprise only some but not all of a compression unit for the block-based encoding scheme, and/or a given tile may span multiple compression units of the block-based encoding scheme for the output being generated. This then means that simply outputting tiles directly to the encoder as they are generated may not provide the encoder with the appropriate data that it requires for generating a given compression block.

The technology described herein addresses this by providing and using an accumulation buffer intermediate the tile buffer and the encoder, which is operable to, as will be discussed further below, buffer tile data that is being generated and provide complete compression units to the encoder for encoding. As will be discussed further below, this can then simplify the encoding operation, for example by allowing the encoder and encoding process simply to support and be configured to encode complete compression units only, and without the need for the encoder and encoding process to be able to handle partial encoding of a compression unit (as might otherwise be the case, for example, where the encoder and encoding process receives tile data that is only part of a compression unit).

The technology described herein can thus provide an improved arrangement for providing compressed outputs in a tile-based graphics processing system.

The graphics processing system of the technology described herein in an embodiment includes a memory system, and a graphics processor.

The memory (memory system) of the graphics processing system may comprise any suitable and desired memory and memory system of the graphics processing system (e.g. of an overall data processing system that the graphics processing system is part of), such as, and in an embodiment, a main memory for the graphics processing system (e.g. where there is a separate memory system for the graphics processor), or a main memory of the data processing system that is shared with other elements, such as a host processor (CPU), of the data processing system.

The graphics processor of the graphics processing system can comprise any suitable and desired graphics processor that is operable to perform tile-based graphics processing.

Subject to any requirements for operation in the manner of the technology described herein, the graphics processor can otherwise comprise any desired and suitable elements, units, processing circuits, etc., that a (tile-based) graphics processor may comprise. Correspondingly the graphics processor can execute any suitable and desired (tile-based) graphics processing pipeline.

In an embodiment, the graphics processor comprises one or more (and in an embodiment a plurality of) processing (shader) cores, which are (each) operable to perform graphics processing operations for a graphics processing pipeline being executed.

The tiles that the graphics processing pipeline generates when generating an output can each comprise any suitable and desired region (area) of the overall output being generated. Each tile should, and in an embodiment does, have the same size and configuration as the other tiles (for a given render output), and should, and in an embodiment does, comprise an appropriate array of contiguous sampling positions of the output, such as 16×16, 32×32 or 64×64 sampling positions of the render output.

The size of the tiles that are being generated may depend, for example, upon the data format (and in particular the data size) of the data that is stored for each sampling position within the tile, for example, and in an embodiment, so as to configure the tile size to be able to be stored entirely within the tile buffer. The tiles are in an embodiment rectangular and in an embodiment square.

The tile buffer should be, and is in an embodiment, configured to store data of a tile being generated locally to the graphics processing pipeline (the processing circuits executing the graphics pipeline) while a tile is generated. In particular, the data for a tile will be, and is in an embodiment, stored locally in the tile buffer as the tile is generated, with the tile (data) then being written out to memory from the tile buffer once the processing of the tile has been completed.

The tile buffer may have any suitable and desired size (data capacity). In an embodiment, the tile buffer is able to store any (and all) tile sizes that the graphics processor may be configured to generate. Thus the tile buffer is in an embodiment able to store a largest tile of data that could be generated by the graphics processor. The tile buffer could also be of a size so as to be able to store plural tiles simultaneously (in parallel), if desired.

When the graphics processor comprises one or more (e.g. a plurality of) processing (shader) cores, each (shader) core in an embodiment comprises a respective tile buffer, configured to store tiles (tile data) that has been generated by that (shader) core. In an embodiment each (shader) core of the graphics processor is arranged to write tiles of data that it is processing to its respective (tile) buffer, for outputting to the memory (via a data encoder, as appropriate).

The tile write-out circuit (unit) that provides tile data from the tile buffer to the accumulation buffer can be configured and operated in any suitable and desired manner. In an embodiment it is configured to, once a finished tile is present in the tile buffer, and in an embodiment in response to the completion of a tile in the tile buffer, write that tile out from the tile buffer appropriately. The write-out unit may receive appropriate control signals to indicate when a tile in the tile buffer has been finished to facilitate this.

The write-out unit may be configured to downsample the tile data as it writes it out from the tile buffer, for example to perform 4× downsampling of the data in the tile buffer.

When writing out tile data from the tile buffer, the write-out unit in an embodiment indicates which compression unit for the render output being generated the tile data relates to, and/or, and in an embodiment and, whether the tile data being written out will be the last tile data that will be generated by the processing (shader) core that the tile buffer relates to for a given compression unit.

Thus, in an embodiment, the write-out unit when providing tile data to the accumulation buffer indicates for a (and in an embodiment for each) sampling position (pixel) that is provided to the accumulation buffer, the compression unit that the tile data in question relates to.

Correspondingly, in an embodiment, the write-out unit when providing tile data to the accumulation buffer indicates when a sampling position (pixel) that is being provided to the accumulation buffer from the tile buffer is the last sampling position pixel (the last piece of tile data) for the compression unit in question that will be provided from the tile buffer (i.e. that will be generated for the render output by the processing (shader) core that the tile buffer relates to).

This is in an embodiment done for each sampling position (pixel) of a tile that is provided to the accumulation buffer by the write out unit (on a sampling position-by-sampling position (pixel-by-pixel) basis).

Thus, in an embodiment, the write-out unit when providing tile data to the accumulation buffer indicates for each piece (item) of the tile data (e.g. sampling position (pixel)) that is provided to the accumulation buffer, the compression unit that the tile data relates to, and whether that tile data is the last tile data for the compression unit in question that will be provided from the tile buffer, and/or be generated for the render output by the processing (shader) core, in question.

As will be discussed further below, this information can then be, and is in an embodiment, used by the accumulation buffer to control the accumulation of compression unit data in (by), and the writing out of compression unit data from, the accumulation buffer.

This information can be provided from the write-out unit to the accumulation buffer in any suitable and desired manner, for example as appropriate sideband signalling, and/or as metadata associated with the tile data, etc. Equally, it could for example, be indicated explicitly for each individual piece of tile data (sampling position/pixel) that is provided to the accumulation buffer, which compression unit that data relates to, or only changes in the compression unit that the tile data relates to could be indicated, for example. Other arrangements would, of course, be possible.

The write-out circuit may be able to determine this information in any suitable and desired manner. For example, suitable parameters, such as the size and/or the configuration of the compression units that the data encoder is to encode for the render output in question, the size and configuration of the output (data array) being generated, and/or the positions and/or size and configuration of tiles within the output being generated may be provided to the write-out unit, so that the write-out unit can determine for any given tile which compression unit data of the tile belongs to.

The write-out unit may also be, for example, provided with a list of tiles being processed by the processing (shader) core in question, and/or the region of the render output that has been allocated to that processing core, so again it can be determined when the final tile data for a given compression unit for the output is being written out

This information may be provided, for example, and in an embodiment, by the driver for the graphics processor that is controlling and initiating the generation of the render output in question by the graphics processor.

The accumulation buffer that is intermediate the tile write-out and the data encoder (and that receives tile data written out from the tile buffer) can be configured in any suitable and desired manner. It in an embodiment has (and comprises) suitable and associated storage, for storing tile data received from the tile buffer before that data is provided to the encoder.

The accumulation buffer correspondingly in an embodiment has an appropriate control circuit or circuits for controlling (and in an embodiment tracking, as will be discussed further below) the storage of tile data in its storage, and for triggering and performing the appropriate write-out of data from its storage to the encoder.

In an embodiment, the accumulation buffer is able to, and in an embodiment does, store data for plural, different compression units (that it is accumulating) at the same time. In an embodiment, respective portions of the accumulation buffer storage will be allocated for respective, different compression units that are being accumulated in the accumulation buffer.

In an embodiment, the accumulation buffer (a control circuit of the accumulation buffer) maintains a record of the compression units that it is currently storing (accumulating), and keeps track of what data for a (and each) compression unit the accumulation buffer currently stores. The accumulation buffer may, for example, maintain an appropriate record, such as a table, with respective entries for compression units that is accumulating, and maintain for each compression unit entry, a record of the data that is currently stored for that compression unit by the accumulation buffer.

The allocation of storage for compression units in the accumulation buffer can be performed in any suitable and desired manner. In an embodiment, when the write-out unit is writing tile data from the tile buffer to the accumulation buffer, the accumulation buffer identifies which compression unit the tile data is for (based on an appropriate indication of this from the write-out unit, for example), and determines whether it is currently accumulating tile data for that compression unit or not.

When the compression unit in question is already being accumulated by the accumulation buffer, then the accumulation buffer will simply store the new tile data for that compression unit appropriately in its storage (and update its record of stored data for that compression unit accordingly).

On the other hand, where the accumulation unit is not currently storing any data for the compression unit in question (i.e. a new compression unit has been started), the accumulation buffer in an embodiment first allocates storage for that new compression unit (and a corresponding entry in its compression unit record), and then starts storing (and tracking) the tile data for that new compression unit

The storage allocation for a given compression unit can be determined in any suitable and desired manner, for example based on the data format and compression parameters for the output in question and compression scheme being used.

In the case where the accumulation buffer does not have sufficient spare storage for a (the) new compression unit, then in an embodiment an existing compression unit is “evicted”, so as to free up storage for the new compression unit. (The eviction process will be discussed in more detail below.)

The accumulation buffer could be configured to operate in the manner of, and be operable as, a cache (subject to any specific requirements of the technology described herein).

However, in an embodiment, the storage for the accumulation buffer is set aside for, and dedicated to, the accumulation buffer, and, e.g., and in an embodiment, is not part of (is other than part of) any cache system or cache hierarchy of the graphics processor and memory system. Thus, for example, and in an embodiment, the accumulation buffer storage is not part of, and is separate from, any L2 cache of the graphics processing system, for example.

In particular, the accumulation buffer storage is in an embodiment configured and operable such that data stored in the accumulation buffer storage will only be evicted from the accumulation buffer storage when it has been determined to evict the compression unit in question (i.e., the accumulation buffer storage will not operate in the manner of a cache, for example, where the writing of new data into the cache can trigger the eviction of existing data from the cache).

Correspondingly, storage in the accumulation buffer for a compression unit (once allocated) will be guaranteed (and there can be no “eviction by accident” of compression unit data stored in the allocated storage) unless and until it is determined to evict the compression unit in question (and eviction of the compression unit in question is triggered).

As discussed above, the tile data is output from the accumulation buffer in and as (integer) compression units to the data encoder for encoding.

The data encoder that is operable to compress tile data for writing to the memory system can be any suitable and desired data encoder.

Subject to the particular operation of the technology described herein, the data encoder can otherwise operate in any suitable and desired manner, such as, and in an embodiment, in accordance with the normal manner for data encoding operations in the graphics processing system in question.

In general, the data encoder should be, and is in an embodiment, operable to compress data provided from the accumulation buffer of the graphics processor before that data is then written towards the memory system.

The data encoder should, and in an embodiment does, comprise an appropriate encoding circuit(s) operable to and configured to encode (compress) data to be output towards the memory system.

The data encoder is configured to use a block-based encoding (compression) scheme, and thus correspondingly, is configured to encode blocks of uncompressed data (“compression units” of uncompressed data) using a block-based encoding (compression) technique.

The data encoder can be configured to use any suitable and desired block-based encoding (compression) technique. The compression scheme may encode data in a lossless or lossy manner, and using variable or fixed-rate compression. The data encoder may support and be configured to be able to perform a plurality of different forms of block-based encoding, which may, e.g., and in an embodiment, be set in use (e.g. on an output-by-output basis).

The block-based encoding (compression) scheme that the data encoder is configured to perform should be, and is in an embodiment, configured to compress input blocks (compression units) having a particular size and/or configuration. Thus the input to the encoding process will be a block (a data array) having a particular size and/or configuration, which the encoding process will then compress to provide an output compressed data block corresponding to that input (uncompressed) data block.

Thus for any given output being generated, each compression unit that is compressed for the input should, and in an embodiment does, comprise an appropriate subset of the data elements (positions) of the output (data array), i.e. corresponding to a particular region of the output. Correspondingly, the output is in an embodiment divided (for encoding purposes) into non-overlapping and regularly sized and shaped compression units (blocks) (regions).

The compression units (blocks) that are compressed in the technology described herein may be any suitable size and configuration. In an embodiment, they are rectangular (having a particular width and height). The compression units (blocks) may be square, but in embodiments are non-square rectangles.

The input compression block (unit) size and/or configuration may be fixed for the data encoder, i.e. such that the data encoder can only (ever) compress input data blocks of a single particular size and/or configuration, but in an embodiment the data encoder can be configured and set to compress different sized and configured input blocks, for example, and in an embodiment, on an output-by-output basis. For example, the compression unit size and configuration for an output (or sequence of outputs) may be set by an application that is using, or by a driver for, the graphics processing system. This may be particularly applicable where the data encoder is able to perform plural different block-based encoding (compression) schemes, as in that case each scheme may, e.g., have a different input data block size and configuration.

In an embodiment the data encoder comprises (local) storage, e.g. a buffer, configured to store the data that is to be encoded, e.g. while the data is being encoded and/or before the data is written towards the memory system, as appropriate. Thus, the data may be temporarily buffered in the data encoder while it is being encoded, before it is output, etc.

The data encoder should, and in an embodiment does (and is configured to) write compressed blocks of tile data that it generates towards the memory system (e.g., and in an embodiment, to a suitable, e.g. frame, buffer in the memory system). In an embodiment, there is a cache hierarchy between the data encoder and the main memory of the memory system, such that the data encoder writes a compressed block of tile data back to the memory system via the cache hierarchy.

In this case, the data encoder in an embodiment outputs the compressed blocks of data that it generates to a shared cache of the graphics processor, and In an embodiment to a cache of the graphics processor that is shared by multiple processing (shader) cores of the graphics processor (where the graphics processor includes plural processing cores). In an embodiment, the (and each) data encoder outputs (writes) the compressed data blocks that it generates to an L2 cache of the cache hierarchy that is intermediate the graphics processor and the main memory (with the compressed data blocks then being written from the L2 cache to the main memory, via any further levels of the cache hierarchy, as appropriate).

In an embodiment, the data encoder is unable to (and not (other than) configured to) fetch data from the memory system itself (does not have (other than has) appropriate interfaces to the memory system for fetching data), but is (simply) operable and configured to encode data that is sent from other units of and in the graphics processor and graphics processing system, and in particular from an (the) accumulation buffer in the manner of the technology described herein. In one embodiment, the encoder is configured solely to receive data for encoding from an (the) accumulation buffer of the technology described herein (the only data source for data to be compressed for the data encoder is an (the) accumulation buffer of the technology described herein).

While it could be the case that the compression units to be used for a given output being generated correspond exactly to the size and configuration of the tiles that are being generated (in which case each tile will simply be compressed as a respective compression unit), the compression units for a given output may not match the tile size. In this case, if the tile size is larger than a compression unit (and, e.g., a tile comprises an integer number of compression units), then each compression unit will comprise a respective part (portion) comprising some but not all of a tile. Conversely, if the tile size is smaller than a compression unit then each compression unit will comprise all and/or respective parts (portions) of a plurality of tiles.

Equally, the layout of the compression units may not match the layout of the tiles for the output being generated, such that each compression unit will comprise data from plural tiles, such as, and in an embodiment, respective parts of plural different tiles. Indeed, the technology described herein is particularly applicable to the situation where compression units cover plural tiles.

Thus, in an embodiment, a (and each) compression unit that is compressed by the data encoder for an output comprises respective portions of plural rendering tiles generated for the output in question. In this case, the compression unit may simply comprise plural (whole/integer) tiles, or it may comprise respective portions (comprising some but not all of the tile) of a plurality of tiles, or a combination of the two, depending upon the respective layouts and configurations of the tiles and compression units for the output being generated.

The data encoder is in an embodiment associated with (and part of) a respective processing (shader) core of the graphics processor. In an embodiment where the graphics processor includes plural processing (shader) cores, then in an embodiment plural, and in an embodiment each, processing (shader) core of the graphics processor has its own respective data encoder (that is operable in the manner of the technology described herein).

In an embodiment, the data encoder and accumulation buffer are all part of the graphics processor. Thus in an embodiment, the graphics processor comprises the tile buffer, write out circuit, data encoder and accumulation buffer (with the data encoder then writing compressed data blocks towards the memory system from the graphics processor).

Thus, another embodiment of the technology described herein comprises a graphics processor comprising:
processing circuits operable to execute a tile-based graphics processing pipeline to generate tiles of an output being generated;
a tile buffer for storing tiles of an output being generated;
a write-out circuit for writing tiles of an output out from the tile buffer;
a data encoder configured to perform block-based compression of uncompressed tile data to be written out from the tile buffer towards a memory system; and
an accumulation buffer intermediate the tile write-out circuit and the encoder; wherein:
the tile write-out circuit is configured to provide tile data from the tile buffer to the accumulation buffer; and
the accumulation buffer is configured to provide tile data to the data encoder for encoding; and
the data encoder is configured to encode blocks of uncompressed data having a particular size for storing in a memory system in a compressed format; and
the accumulation buffer is configured to provide arrays of data that are equal to the particular size to the data encoder for encoding.

Another embodiment of the technology described herein comprises a method of operating a graphics processor, the graphics processor comprising:
processing circuits operable to execute a tile-based graphics processing pipeline to generate tiles of an output being generated;
   a tile buffer for storing tiles of an output being generated; and
   a write-out circuit for writing tiles of an output out from the tile buffer;
   a data encoder configured to perform block-based compression of uncompressed tile data to be written from the tile buffer, the data encoder configured to encode blocks of uncompressed data having a particular size for storing in a memory system in a compressed format; and
   an accumulation buffer intermediate the tile write-out circuit and the data encoder;
   the method comprising:
   the tile write-out circuit providing tile data from the tile buffer to the accumulation buffer;
   the accumulation buffer providing an array of tile data that is equal to the particular size to the data encoder for encoding; and
   the data encoder compressing the array of tile data that is equal to the particular size provided by the accumulation buffer to generate a compressed block of tile data, and writing the compressed block of tile data towards a memory system.

As will be appreciated by those skilled in the art, these embodiments of the technology described herein can, and do, comprise any one or more or all of the features of the technology described herein described herein, as appropriate.

In an embodiment, the tile buffer, write-out circuit, data encoder and accumulation buffer are part of and comprised in and for a processing (shader) core of the graphics processor.

Thus, in an embodiment, the graphics processor comprises a processing (shader) core, which shader core comprises a tile buffer, a write-out circuit, an accumulation buffer and data encoder in accordance with the technology described herein. In an embodiment, the graphics processor comprises plural processing (shader) cores, with plural, and in an embodiment each, of the processing (shader) cores comprising (its own, respective) tile buffer, write-out circuit, accumulation buffer and data encoder (with the data encoder, in an embodiment, then writing the data out from the shader core to the memory system).

Thus, in an embodiment, the graphics processor comprises a plurality of processing (shader) cores, with each (shader) core comprising a tile buffer, a write-out circuit, an accumulation buffer and a data encoder in the manner of the technology described herein, and being respectively operated and operating in the manner of the technology described herein.

In this case, the write-out unit, and accumulation buffer operation discussed above is in an embodiment performed for each processing (shader) core, independently, and in respect of that processing (shader core) only. Thus in this case, it will, for example, be indicated when the last tile data for a given compression unit has been provided to the shader core's accumulation buffer for the shader core in question (irrespective of whether any of the other shader cores may still be producing tile data for that compression unit), with the corresponding compression unit “eviction” and encoding process then being triggered for the shader core in question (and again irrespective of whether other data for the compression unit may still to be produced by other shader cores).

(As discussed herein, the Applicants have recognised that in the case where a graphics processor comprises plural shader cores, each operable to generate tiles of an output at the same time, it may be that the tiles that make up a given compression unit may be allocated to and processed by different ones of the shader cores (i.e. such that an individual shader core will not produce all the tile data for the compression unit in question). In this case, in embodiments of the technology described herein at least, rather than trying to track and determine when all the shader cores that are producing tiles for a compression unit have completed their processing, the compression unit processing and encoding is simply considered and handled on the basis of the individual shader cores only.)

The accumulation buffer is operable to provide data (in the form of complete compression units) to the data encoder (to write data out from the accumulation buffer storage to the data encoder) for the data encoder to then encode as respective compression units (blocks).

The operation to provide data from the accumulation buffer (to write data out from the accumulation buffer storage) to the data encoder for this purpose (to evict a compression unit from the accumulation buffer storage to the data encoder for encoding) can be triggered in any suitable and desired manner.

In one embodiment, the data for a compression unit is provided from the accumulation buffer (is evicted from the accumulation buffer storage) when and once the accumulation buffer has accumulated (is storing data for) the entire compression unit in question. This may be determined, for example, and in an embodiment, from the tracking of the data that is stored for a compression unit by the accumulation buffer. Thus, once the accumulation buffer stores all the data for a given compression unit, in an embodiment that compression unit is provided from the accumulation buffer to the data encoder for encoding (is evicted from the accumulation buffer storage to the data encoder for encoding).

In an embodiment, the eviction of a compression unit from the accumulation buffer (the providing of tile data for a compression unit from the accumulation buffer to the encoder) is triggered based on and in response to an indication that the final piece of tile data (sampling position/pixel) for a given (the) compression unit has been written for the tile buffer (processing core) in question has been written to the accumulation buffer. (As this will then mean that there will be no more data for the compression unit in question provided from the tile buffer (processing core) in question.)

Thus, in an embodiment, when (and in response to) a “final” tile data indication for a compression unit is provided to the accumulation buffer, then in an embodiment an eviction process for the compression unit in question is triggered and performed.

The same eviction process is in an embodiment also triggered and performed in the case where an existing compression unit needs to be evicted so as to free up storage for a new compression unit.

(As discussed above, in an embodiment, the write-out unit is operable to indicate to the accumulation buffer when the last piece of tile data for the given compression unit has been written to the accumulation buffer.)

As discussed above, the eviction of a compression unit may also be (and is in an embodiment) triggered by storage for a new compression unit needing to be allocated in the allocation buffer. In this case, the eviction operation is in an embodiment triggered in response to the need to allocate the storage for a new compression unit in the accumulation buffer (and there not being enough spare storage capacity in the accumulation buffer storage for that new compression unit).

The compression unit that is evicted in this case may be selected as desired, for example using any suitable and desired eviction policy, such as a least recently used eviction policy. Other arrangements would, of course, be possible.

In an embodiment, the eviction process comprises (first) determining for the compression unit to be evicted, whether the accumulation buffer stores all of the data for that compression unit (which may be determined, for example, and in an embodiment, from the tracking of the data stored for the compression unit performed by the accumulation buffer). In the case where all of the data for the compression unit to be evicted is stored by the accumulation buffer, then the complete compression unit can be, and is in an embodiment, simply provided to the data encoder for encoding.

As discussed above, the Applicants have recognised that not all of a given compression unit may be generated and output via the same tile buffer (e.g.

processing core) of the graphics processor. In this case, the complete compression unit may never be accumulated in the accumulation buffer associated with the tile buffer/processing core in question. In this case, when the eviction of the compression unit is triggered, the compression unit will be “incomplete” (in the sense that the accumulation buffer will not store all (will only store some but not all) of the data for the complete compression unit).

Accordingly, in an embodiment, it is also possible to trigger the eviction of an “incomplete” compression unit from the accumulation buffer storage (from the accumulation buffer). Thus in an embodiment, the graphics processor is operable to and configured to, also be able to evict “incomplete” compression units from the accumulation buffer.

In this case, where an “incomplete” compression unit is triggered to be evicted from the accumulation buffer, then in an embodiment, in order to allow the accumulation buffer to still provide a complete version of the compression unit to the encoder for encoding, the accumulation buffer is operable to and configured to be able to fetch any missing data that is required for (to complete) the compression unit from the memory system.

Thus, in an embodiment, the compression unit eviction process (for sending a compression unit to the encoder) comprises (first) determining for the compression unit to be evicted, whether the accumulation buffer stores all of the data for that compression unit, and in the case that not all of the data for the compression unit to be evicted is stored by the accumulation buffer, the accumulation buffer fetching the missing data for the compression unit (from the memory system), and when it has received the missing data for the compression unit, then providing the complete (entire) compression unit to the data encoder for encoding.

In these arrangements, the accumulation buffer may fetch the missing data for a compression unit from the memory system in any suitable and desired manner. For example, it may itself have an appropriate interface to access the memory system, for example via the cache hierarchy.

In an embodiment, the fetching of compression unit data to the accumulation buffer for an incomplete compression unit is achieved via and using another component (unit) of the graphics processor (and in an embodiment of the processing (shader) core of the graphics processor in question), which is operable to fetch data from memory.

In an embodiment, any missing compression unit data is fetched for the accumulation buffer by and via a texture mapper (a texture mapping unit) of the graphics processor (of the shader core of the graphics processor). The Applicants have recognised in this regard, that a texture mapper (texture mapping unit) of a graphics processor will already be operable to fetch data for use by the graphics processor, and include, for example, the appropriate data fetching and decoding (decompressing) functionality and processing circuits for that purpose. Thus the texture mapping unit will already provide and support functionality for fetching any missing compression unit data for the accumulation buffer.

Thus, in an embodiment, the accumulation buffer has an appropriate communications interface with a texture mapping unit (circuit) of the graphics processor, via which it can request and trigger the texture mapping unit to fetch tile data for compression units for then providing to the data encoder together with tile data for a compression unit that is stored by the accumulation buffer. Correspondingly, the texture mapping unit should be, and is in an embodiment, configured and operable to respond to such requests from an accumulation buffer appropriately.

Thus, in an embodiment, the accumulation buffer is operable and configured to request any data for a compression unit that is to be evicted that the accumulation buffer does not store from the memory system (in an embodiment via a texture mapping unit of the graphics processor), and when all of the required data is returned from the memory system, to combine that returned data with the already stored data for the compression unit so as to provide a complete version of the compression unit to the data encoder for encoding.

Again, in an embodiment where a (and each) respective processing (shader) core of the graphics processor has its own accumulation data encoder, etc., the processing (shader) core in an embodiment also comprises its own (respective) texture mapping unit, which operates in the above manner with the accumulation buffer for that processing (shader) core.

In an embodiment, the graphics processor and graphics processing system is configured and operable such that only one accumulation buffer can be performing such an eviction operation for a given compression unit at any one time (so as to, for example, and in an embodiment, avoid multiple accumulation buffers (e.g. shader cores) trying to fetch data for and compress the same compression unit in this manner at the same time). (As discussed above, different shader cores of the graphics processor may be generating tiles for different parts of the same compression unit. It is therefore desirable to ensure that only one accumulation buffer has access to a compression unit for performing such an eviction operation at any one time.)

Thus, in an embodiment, once the process for evicting an “incomplete” compression unit has been started for an accumulation buffer (shader core), that compression unit is “locked”, such that no other accumulation buffers (shader cores) can trigger the evicting and encoding of that compression unit until such time as the current encoding of the compression unit has been completed.

Such locking of a compression unit whilst it is being encoded in this manner can be achieved in any suitable and desired manner. In an embodiment a mutex arrangement is used for this purpose, i.e. such that an accumulation buffer (processing core) has to be in possession of a mutex for the compression unit in question in order to be able to perform the eviction and encoding process for that compression unit (and any accumulation buffer that is not in possession of the mutex for a compression unit is unable to and prevented from being able to evict and encode the compression unit in question).

Correspondingly, when a compression unit is to be evicted in this way, the accumulation buffer in an embodiment requests a mutex for the compression unit in question, and then once it has acquired the mutex, performs the eviction and encoding operation, before then releasing the mutex.

Thus, in an embodiment, the graphics processor is operable to maintain a set of mutexes for compression units, with there in an embodiment being a separate mutex for each compression unit for the output being generated, with accumulation buffer(s) correspondingly being able to acquire the mutexes in the manner discussed above.

The mutexes are in an embodiment organised and administered at a “global” level, i.e. there is a global set of compression unit mutexes used for all the accumulation buffers and shader cores of the graphics processor (rather than there being separate sets of mutexes for each individual accumulation buffer or shader core, for example). (Although the mutexes may be spread out in different units, if desired (with a hashing of the address used to lock a mutex being used to find which unit contains the mutex, for example)).

Correspondingly, the graphics processor in an embodiment comprises an appropriate mutex handling circuit that administers the compression unit mutexes and from which mutexes can be requested by an accumulation buffer/shader core, when required.

As well as preventing more than one accumulation buffer being able to perform the above eviction process for a given compression unit at any one time, in an embodiment, the graphics processor and graphics processing system is operable and configured so as to prevent any and/or other texture mapping units in the graphics processor from reading the data of a (the) compression unit that is being evicted and encoded in this manner (an “incomplete” compression unit that is to undergo eviction from an accumulation buffer).

In other words, in an embodiment, the compression unit in question is also “locked” from the point of view of other consumers (and in an embodiment other texture mappers) in the graphics processor and graphics processing system, such that data of that compression unit will not be read and used until the new encoded version of the compression unit has been stored in the memory system.

Thus, in an embodiment, when a compression unit is to be evicted and encoded in this manner, any (copies of) data for that compression unit other than the data for the compression unit which is stored in the accumulation buffer in question and in the memory system itself (any data for the compression unit that is in a cache of the cache hierarchy of the memory system, other than any cache for the texture mapping unit that is involved in the eviction process for the compression unit) is invalidated.

In an embodiment, the compression unit in question is “locked”, so as to prevent all other texture mappers in the graphics processor from reading the data of the compression unit that is being encoded.

This can be done in any appropriate and desired manner, and is in an embodiment achieved by invalidating any and all data related to the compression unit in question in all texture mappers in the GPU (such that they will not use any cached data for the compression unit in question).

In an embodiment, this is done via a (the) cache coherency protocol of the cache hierarchy for the graphics processor and graphics processing system in question. In an embodiment the accumulation buffer sends an appropriate compression unit “invalidation” request via the coherency protocol for this purpose.

In an embodiment, (compressed) compression units are stored as respective, separate, linked headers and payloads, and a compression unit is “locked” in this way by locking the header (the cache line storing the header) for the compression unit in question, such that that correspondingly causes invalidation of data related to the compression unit in all texture mappers in the graphics processor.

Once the new, encoded compression unit has been written to the memory system, then the compression unit is in an embodiment “unlocked”, so that texture mappers are able to read the compression unit (from the memory system) (again).

Again, this is in an embodiment achieved in the appropriate manner for the coherency protocol used in the graphics processor and graphics processing system in question, for example by writing an appropriate (valid) header to the memory system for the (compressed) compression unit once the payload data for the compression unit has been written to the memory system.

It will be appreciated from the above, that in an embodiment of the above operation where an “incomplete” compression unit is being evicted (is undergoing the appropriate read-modify-write operation to be compressed and written out), there are, effectively, two “locks” for the compression unit, a first lock, that is (in an embodiment) implemented using the “mutex” mechanism, and whose purpose is to serialise multiple read-modify-write operations on the same compression unit, and a second lock, that is (in an embodiment) implemented using the coherency protocol as discussed above, whose purpose is to invalidate data (from texture mappers) for the compression unit and also prevent the compression unit being accessed (by texture mappers) while it is being updated.

The second lock (that invalidates the data) is in an embodiment acquired after the first lock is acquired, and in an embodiment after any missing data for the compression unit has been read (e.g. through the texture mapper).

Thus in an embodiment, the read-modify-write operation for the eviction process for a compression unit accordingly comprises acquiring the first lock, reading any missing data (in an embodiment through the texture mapper), acquiring the second lock, encoding the compression unit, writing the compressed data for the compression unit to memory, releasing the second lock, and then releasing the first lock.

Other arrangements would, of course, be possible.

In the operation of the above embodiments, data for compression units is accumulated in the accumulation buffer before being encoded and written to memory. This operation is in particular appropriate in the case where any given rendering tile does not provide a complete compression unit for encoding (i.e.

where data from more than one rendering tile will be required for a compression unit).

The Applicants have recognised that there could be situations where data from a single rendering tile provides a complete compression unit for encoding. This could be the case, for example, where the rendering tiles are equal to or larger than the compression units that the block-based encoding uses.

In this case, while it would still be possible simply to accumulate compression unit data in storage of the accumulation buffer and then output the compression units, e.g. “immediately”, in an embodiment, in the case where a single tile being written out from the tile buffer provides all the data required for a compression unit, then rather than storing the tile data in the accumulation buffer and then providing it from the accumulation buffer storage to the encoder, the tile data is instead streamed directly to the encoder, bypassing (without being stored in) the storage of the accumulation buffer, as it is written out from the tile buffer.

This may be via a communications path that bypasses the accumulation buffer entirely, or there may, for example, be a communication path that allows tile data to pass through the accumulation buffer without being (temporarily) stored in the storage of the accumulation buffer.

In this case, the accumulation buffer will not accumulate any data for the tile, but rather the tile data will be passed directly to the encoder without being accumulated by the accumulation buffer, and, e.g., and in an embodiment, such that the tile data is being consumed (encoded) as the data is being written out.

Correspondingly, there will be no allocation of storage for the compression unit in the accumulation buffer storage.

Thus, when a tile to be output from the tile buffer has a data size greater than the particular data size, the whole of the tile is in an embodiment streamed to the data encoder, such that the data encoder is then able to encode the data as a respective compression block, as it receives it. This helps to streamline the process of outputting and encoding the tile data.

The possibility to “stream” tile data directly to the encoder in this manner may be recognised and determined in any suitable and appropriate manner. For example, this may be, and in an embodiment is, based on the known tile and compression unit configuration and size, etc., for the render output being generated (which information may, as discussed above, be signalled to the write-out circuit and/or accumulation buffer appropriately, e.g. by a driver for the graphics processor causing the tile and compression unit parameters to be set).

The technology described herein also extends to the data encoder and accumulation buffer operation and configuration alone.

Thus, another embodiment of the technology described herein comprises an apparatus for encoding tile data to be written to a memory system from a tile-based graphics processor, the apparatus comprising:
a data encoder configured to perform block-based compression of uncompressed tile data to be written to a memory system; and
an accumulation buffer associated with the encoder;
   wherein:
the accumulation buffer is configured to receive tile data to be written to a memory system and to provide tile data to be written to a memory system to the data encoder for encoding;
the data encoder is configured to encode compression units of uncompressed data having a particular size for storing in a compressed format; and
the accumulation buffer is configured to provide arrays of data that are equal to the particular size to the data encoder for encoding.

Correspondingly, another embodiment of the technology described herein comprises a method of operating an apparatus for encoding data to be written to a memory system, the apparatus comprising:
a data encoder configured to perform block-based compression of uncompressed data to be written to a memory system, the data encoder configured to encode compression units of uncompressed data having a particular size for storing in a compressed format; and
an accumulation buffer associated with the encoder;
   the method comprising:
the accumulation buffer receiving data to be written to a memory system and providing an array of data that is equal to the particular size to the data encoder for encoding; and
the data encoder compressing the array of data that is equal to the particular size provided by the accumulation buffer to generate a compressed block of data, and writing the compressed block of data towards a memory system.

As will be appreciated by those skilled in the art, these embodiments of the technology described herein can, and, in an embodiment, do, include, as appropriate, any one or more or all of the features of the technology described herein described herein.

The above describes the main elements and operation of the graphics processor and graphics processing pipeline that are relevant to operation in the manner of the technology described herein.

As will be appreciated by those skilled in the art, the graphics processor can otherwise include and execute, and in an embodiment does include and execute, any one or one or more, and in an embodiment all, of the processing stages and circuits that graphics processors and graphics processing pipelines may (normally) include.

In an embodiment, the graphics processor comprises, and/or is in communication with a memory system, one or more memories, and/or memory devices that store the data described herein, and/or that store software for performing the processes described herein. The graphics processor may also be in communication with a host microprocessor, and/or with a display for displaying images based on the output of the graphics processor.

The output being generated may comprise any output that can and is to be generated by the graphics processor and processing pipeline. The technology described herein can be used for all forms of output that a graphics processor and processing pipeline may be used to generate, such as frames for display, render-to-texture outputs, etc. In an embodiment, the output is an output frame, and in an embodiment an image.

In an embodiment, the various functions of the technology described herein are carried out on a single graphics processing platform that generates and outputs the (rendered) data that is, e.g., written to a frame buffer for a display device.

The various functions of the technology described herein can be carried out in any desired and suitable manner. For example, unless otherwise indicated, the functions of the technology described herein can be implemented in hardware or software, as desired. Thus, for example, unless otherwise indicated, the various functional elements, stages, and “means” of the technology described herein may comprise a suitable processor or processors, controller or controllers, functional units, circuitry, circuits, processing logic, microprocessor arrangements, etc., that are configured to perform the various functions, etc., such as appropriately dedicated hardware elements (processing circuits/circuitry) and/or programmable hardware elements (processing circuits/circuitry) that can be programmed to operate in the desired manner.

It should also be noted here that, as will be appreciated by those skilled in the art, the various functions, etc., of the technology described herein may be duplicated and/or carried out in parallel on a given processor. Equally, the various processing stages may share processing circuitry/circuits, etc., if desired.

Furthermore, unless otherwise indicated, any one or more or all of the processing stages of the technology described herein may be embodied as processing stage circuits, e.g., in the form of one or more fixed-function units (hardware) (processing circuits), and/or in the form of programmable processing circuits that can be programmed to perform the desired operation. Equally, any one or more of the processing stages and processing stage circuitry of the technology described herein may be provided as a separate circuit element to any one or more of the other processing stages or processing stage circuits, and/or any one or more or all of the processing stages and processing stage circuits may be at least partially formed of shared processing circuits.

Subject to any hardware necessary to carry out the specific functions discussed above, the graphics processor can otherwise include any one or more or all of the usual functional units, etc., that graphics processors include.

It will also be appreciated by those skilled in the art that all of the described embodiments of the technology described herein can, and, in an embodiment, do, include, as appropriate, any one or more or all of the features described herein.

The methods in accordance with the technology described herein may be implemented at least partially using software e.g. computer programs. It will thus be seen that the technology described herein may provide computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processor may be a microprocessor system, a programmable FPGA (field programmable gate array), etc.

The technology described herein also extends to a computer software carrier comprising such software which when used to operate a display controller, or microprocessor system comprising a data processor causes in conjunction with said data processor said controller or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus, in a further broad embodiment the technology described herein provides computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions either fixed on a tangible, non-transitory medium, such as a computer readable medium, for example, diskette, CDROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrinkwrapped software, preloaded with a computer system, for example, on a system ROM or fixed disk, or distributed from a server or electronic bulletin board over a network, for example, the Internet or World Wide Web.

Embodiments of the technology described herein will now be described.

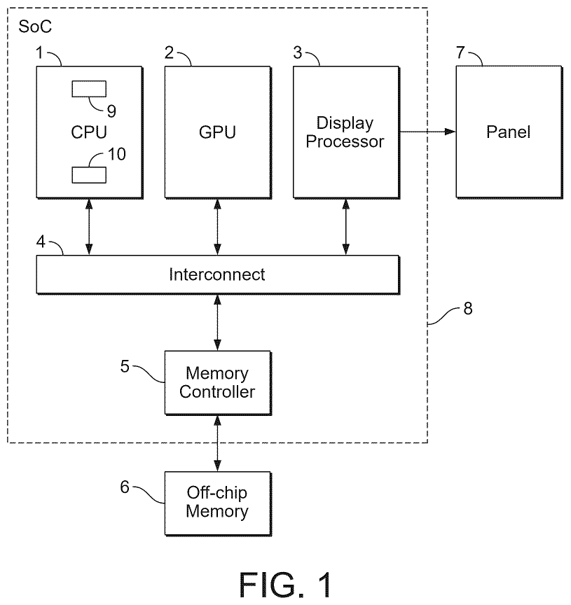

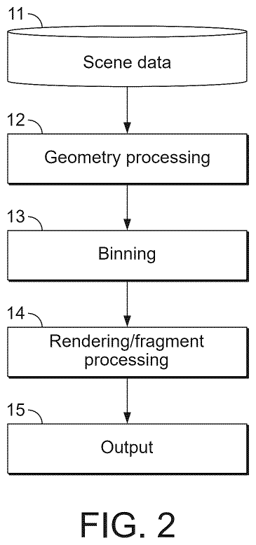

FIG. 1 shows an exemplary system on chip (SoC) graphics processing system 8 that comprises a host processor comprising a central processing unit (CPU) 1, a graphics processor (GPU) 2, a display processor 3, and a memory controller 5. As shown in FIG. 2, these units communicate via an interconnect 4 and have access to off-chip memory 6. In this system, the graphics processor 2 will render frames (images) to be displayed, and the display processor 3 will then provide the frames to a display panel 7 for display.

In use of this system, an application 9 such as a game, executing on one or more host processors (CPUs) 1 will, for example, require the display of frames on the display panel 7. To do this, the application will submit appropriate commands and data to a driver 10 for the graphics processor 2, e.g. that is executing on a CPU 1. The driver 10 will then generate appropriate commands and data to cause the graphics processor 2 to render appropriate frames for display and to store those frames in appropriate frame buffers, e.g. in the main memory 6. The display processor 3 will then read those frames into a buffer for the display from where they are then read out and displayed on the display panel 7 of the display.

In the present embodiment, the graphics processor 2 executes a graphics processing pipeline that processes graphics primitives, such as triangles, when generating an output, such as an image for display.

FIG. 2 shows schematically the processing sequence of the graphics processing pipeline executed by the graphics processor 2 when generating an output in the present embodiments.

FIG. 2 shows the main elements and pipeline stages. As will be appreciated by those skilled in the art there may be other elements of the graphics processor and processing pipeline that are not illustrated in FIG. 2. It should also be noted here that FIG. 2 is only schematic, and that, for example, in practice the shown pipeline stages may share significant hardware circuits, even though they are shown schematically as separate stages in FIG. 2. It will also be appreciated that each of the stages, elements and units, etc., of the processing pipeline as shown in FIG. 2 may, unless otherwise indicated, be implemented as desired and will accordingly comprise, e.g., appropriate circuitry, circuits and/or processing logic, etc., for performing the necessary operation and functions.

As shown in FIG. 2, for an output to be generated, a set of, e.g. scene data 11, including, for example, and inter alia, a set of vertices (with each vertex having one or more attributes, such as positions, colours, etc., associated with it), a set of indices referencing the vertices in the set of vertices, and primitive configuration information indicating how the vertex indices are to be assembled into primitives for processing when generating the output, is provided to the graphics processor, for example, and in an embodiment, by storing it in the memory 6 from where it can then be read by the graphics processor 2.

This scene data 11 may be provided by the application (and/or the driver in response to commands from the application) that requires the output to be generated, and may, for example, comprise the complete set of vertices, indices, etc., for the output in question, or, e.g., respective different sets of vertices, sets of indices, etc., e.g. for respective draw calls to be processed for the output in question. Other arrangements would, of course, be possible.

There is then a geometry processing stage or stages 12, which performs appropriate geometry processing of and for the scene data to generate the data that will then be required for rendering the output. This geometry processing 12 can comprise any suitable and desired geometry processing that may be performed as part of a graphics processing pipeline.

In the present embodiments, this geometry processing 12 comprises at least performing vertex processing (vertex shading) of attributes for vertices to be used for primitives for the render output being generated. In particular, appropriate vertex position shading is performed to transform the positions for the vertices from the, e.g. “model” space in which they are initially defined, to the, e.g., “screen”, space that the output is being generated in. In embodiments, the vertex shading also comprises generating and/or processing other, non-position attributes of vertices (varyings/varying shading). It would also be possible for some or all the varying shading to be deferred from the geometry processing 12 and, for example, to be triggered at the binning or rendering stages instead, if desired.

As well as appropriate vertex shading, the geometry processing 12 may comprise any other form of geometry processing that is desired, such as one or more of tessellation shading, transform feedback shading, mesh shading, or task shading. This geometry shading may also generate and/or process attributes for vertices, and/or it may process and generate attributes for primitives as well.

Once the desired geometry processing 12 has been performed, there is then, in the present embodiments, as shown in FIG. 2, a binning/tiling stage 13. The graphics processor 2 in the present embodiments is a tile-based graphics processor and so generates respective output tiles of an overall output (e.g. frame) to be generated separately to each other, with the set of tiles for the overall output then being appropriately combined to provide the final, overall output.

The binning process 13 operates to generate appropriate data structures for determining which primitives need to be processed for respective rendering tiles of the output being generated. For example, it may sort the primitives into appropriate primitive lists, which indicate the primitives to be processed for respective tiles or sets of tiles. Alternatively, it may generate other data structures, such as hierarchies of bounding boxes, that can then be used at the rendering/fragment processing stage to identify those primitives that need to be processed for a respective tile.

The binning/tiling process 13 may also cull primitives that are not visible (e.g. that fall outside the view frustum, and/or based on the facing direction of the primitives).

As part of the geometry processing 12 and/or the binning/tiling operation 13 the primitives to be processed will be “assembled”. The primitives will, as discussed above, be assembled from a set of indices referencing vertices in a set of vertices for the render output processing being performed, based on primitive configuration information indicating how the vertex indices are to be assembled into primitives for processing when generating the render output.

Such primitive assembly may be performed as part of and at an appropriate stage of the geometry processing 12 and/or as part of the binning/tiling processing 13, as desired. There may also, if desired, be two (or more) “primitive assembly” operations. For example, an initial primitive assembly operation could be performed to identify those vertices that will actually be used for the render output being generated before performing any vertex shading of the vertices, but with there then being a later primitive assembly stage that provides a sequence of assembled primitives for the binning/tiling stage 13.

Once the binning/tiling process 13 has generated the necessary data structures for identifying the primitives to be processed for respective tiles of the render output, the primitives can then be and are then subjected to appropriate rendering/fragment processing 14. This operation is performed in the present embodiments on a tile-by-tile basis, using the data structures generated by the tiling/binning process 13 to identify those primitives that need to be processed for a respective tile.

The rendering/fragment processing 14 can comprise any suitable and desired rendering and fragment processing operations that may be performed. Thus it may comprise, for example, first rasterising primitives to be processed for a tile to fragments, and then processing those fragments accordingly (e.g., and in an embodiment, by performing appropriate fragment shading of the fragments). The rendering/fragment processing 14 may also or instead comprise performing ray tracing operations, such as performing the rendering by tracing rays for respective fragments representing respective sets of one or more sampling positions of the output being generated. Hybrid ray tracing operations would also be possible, if desired.

The output of the rendering/fragment processing 14 (the rendered fragments) is written to a tile buffer (not shown). Once the processing for the tile in question has been completed, then the tile will be written to an output data array in memory 6, and the next tile processed, and so on, until the complete output data array 15 has been generated. The process will then move on to the next output data array (e.g. frame), and so on.

The output data array 15 may typically be an image for a frame intended for display on a display device, such as a screen or printer, but may also, for example, comprise intermediate render data intended for use in later rendering passes (also known as a “render to texture” output), or for deferred rendering, or for hybrid ray tracing, etc.

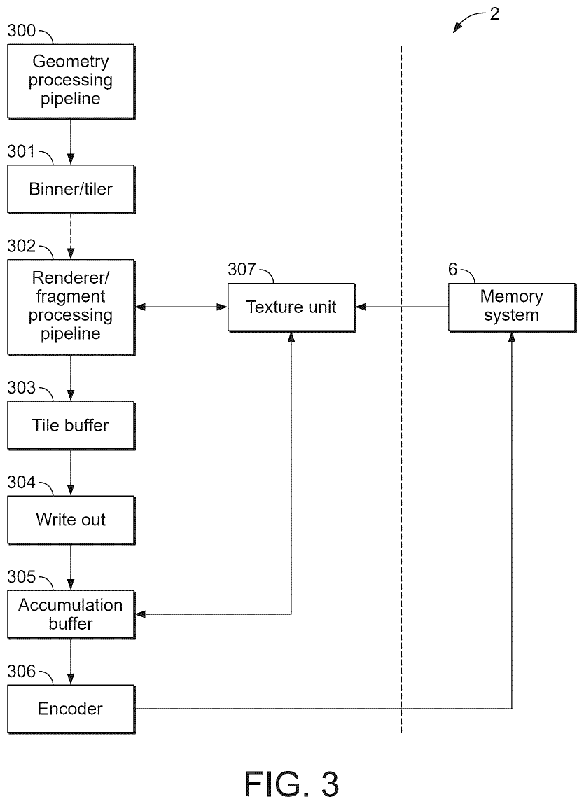

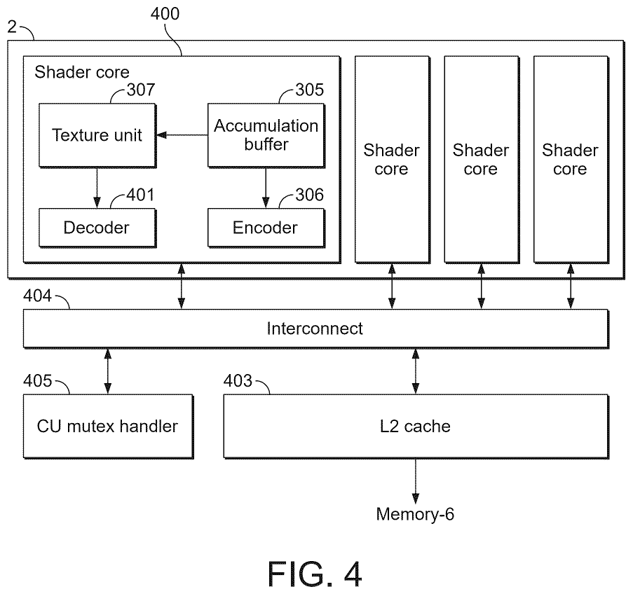

FIGS. 3 and 4 show in more detail an embodiment of a graphics processor (GPU) 2 that can execute a graphics processing pipeline of the form shown in FIG. 2, and that can be operated in the manner of the technology described herein.

FIGS. 3 and 4 shows the particular elements and units of the graphics processor in the present embodiments that are relevant to operation in the manner of the technology described herein. It will be appreciated that the graphics processor may, and typically will, comprise other elements and components that are not shown in FIGS. 3 and 4.

As shown in FIG. 3, the graphics processor 2 in the present embodiments comprises appropriate processing circuits operable to execute a geometry processing pipeline 300 to perform the geometry processing operations as discussed above with reference to step 12 of FIG. 2. In the present embodiments, this geometry processing pipeline is implemented and the geometry processing performed by executing appropriate geometry processing shader programs in a programmable processing (shader) core or cores of the graphics processor 2. Other arrangements, such as having a fixed function geometry processing pipeline would be possible, if desired.

There is then a binning/tiling circuit or circuits (binner/tiler) 301, that performs the binning process discussed above with reference to step 13 of FIG. 2.

The graphics processor 2 then comprises appropriate processing circuits to execute a rendering/fragment processing pipeline 302 (step 14 of FIG. 2). Again in the present embodiments, the fragment processing pipeline 302 is implemented by executing appropriate fragment processing shader programs on a shader core or cores of the graphics processor 2, but fixed function fragment processing could also be performed, if desired.

In the present embodiments, as the graphics processor 2 is a tile-based graphics processor, the fragment processing pipeline 302 operates on and to generate respective tiles of an output being generated, and so correspondingly writes the output for a tile or tiles that it is generating to a tile buffer 303 which stores the tile data locally while a tile is being processed.

Once the processing for a tile has been finished, it can then be written out from the tile buffer by a write-out circuit 304 towards the memory system 6.

As shown in FIG. 3, the tile data is written out from the tile buffer in the present embodiments via an accumulation buffer 305 and an encoder 306. The operation of the accumulation buffer 305 and encoder 306 in the present embodiments will be described in more detail below.

As also shown in FIG. 3, the fragment processing pipeline 302 has access to a texture unit (texture mapper) 307 which is operable to perform texturing operations on texture data stored in the memory system 6 and to provide the results of those texturing operations to the fragment processing pipeline 302 for use.

As shown in FIG. 3, the accumulation buffer 305 also has an interface to and can communicate with the texture unit (texture mapper) 307. This operation will again be discussed in more detail below.

FIG. 4 shows further elements of the graphics processor 2 in the present embodiments in more detail.

In particular, FIG. 4 shows in more detail the configuration of the processing (shader) cores in the graphics processor 2 in the present embodiments.

As shown in FIG. 4, it is assumed that the graphics processor 2 comprises a plurality of shader cores 400, with each shader core having its own respective texture unit 307, accumulation buffer 305 and encoder 306.

As shown in FIG. 4, each shader core 400 in the present embodiments also includes a corresponding decoder 401 that is operable to decode data that is stored in a compressed form in the memory for provision to the texture unit 307. Although the encoder 306 and decoder 401 are shown as separate components in FIG. 4, it will be appreciated that they can be provided in the form of a combined encoder/decoder (codec) if desired.

It will also be appreciated that the shader cores 400 in the graphics processor 2 in the present embodiments can and will include other components not shown in FIG. 4, such as a programmable execution unit for executing program instructions to perform graphics processing operations, etc., that are necessary for the operation of a shader core to execute shader programs to perform processing operations.

FIG. 4 also shows that the shader cores and in particular the encoder 306 and texture unit 307 of each shader core are operable to and configured to communicate with the memory system 6 via an appropriate cache hierarchy, including in particular an L2 cache 403. (Other cache hierarchy arrangements would be possible, such as comprising multiple cache levels, if desired.)

An appropriate interconnect 404 is provided to allow the shader cores to communicate with the L2 cache 403 and thus the memory 6.

FIG. 4 also shows a mutex handler 405 that is in communication with the shader cores 400 of the graphics processor. The mutex handler 405 maintains a set of mutexes, including a respective mutex for each compression unit that a shader core of the graphics processor is currently generating data for. Each mutex can be assigned to the accumulation buffer of only one shader core at any one time. The mutex handler 405 keeps track of the identity of the accumulation buffer (if any) that a mutex is currently assigned to. The operation of the mutex handler 405 in the present embodiments will be discussed in more detail below.

The data decoder 401 is operable to decompress data received from the memory 6 for use by the texture unit 307 of the graphics processor 2.

The encoder 306 is operable to compress (tile) data from the accumulation buffer 305 prior to sending that data to the memory 6 (via the L2 cache 403).

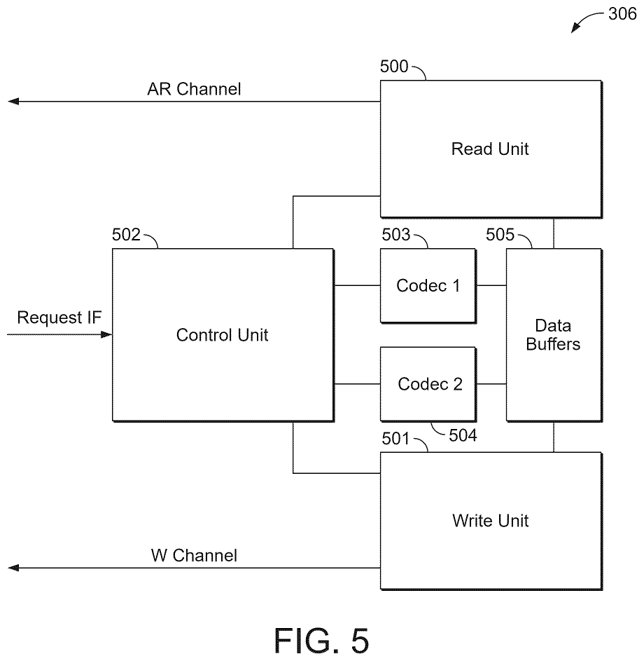

FIG. 5 shows an embodiment of the data encoder 306 in the present embodiments. As shown in FIG. 5, the (and each) data encoder 306 includes respective read 500 and write 501 units (circuits) that are operable to, respectively, receive data from the accumulation buffer 305, and write data to the L2 cache 403 (and thus to the memory system 6).

The data encoder 17 also includes an appropriate control unit (circuit) 502 that receives requests for encoding and controls the data encoder 306 to respond to those requests accordingly and appropriately.

As shown in FIG. 5, the data encoder 306 also includes one or more codecs 503, 504, and a set of data buffers 505 for temporarily storing data in the data encoder 306 while that data is processed.

The data encoder 306 can include any desired number of codecs, e.g. that are each respectively operable to perform a different encoding (compression) scheme. For example, one codec may be configured to perform an appropriate variable rate compression scheme, with the other codec being configured to perform an alternative, e.g. fixed rate compression scheme.

Other arrangements would, of course, be possible.

In the present embodiments, the encoder 306 is configured to and operable to perform block-based encoding, i.e. in which input data arrays of a particular “block” (compression unit) size are encoded (compressed) as respective compression units.

Thus the encoder will take as an input compression units of a particular data size (comprising data arrays of a particular size (WxH)), and then compress each such compression unit to provide a compressed output corresponding to the compression unit in question. Any given render output will accordingly be divided into an array of compression units of the particular size, with each such compression unit then being compressed and output independently.

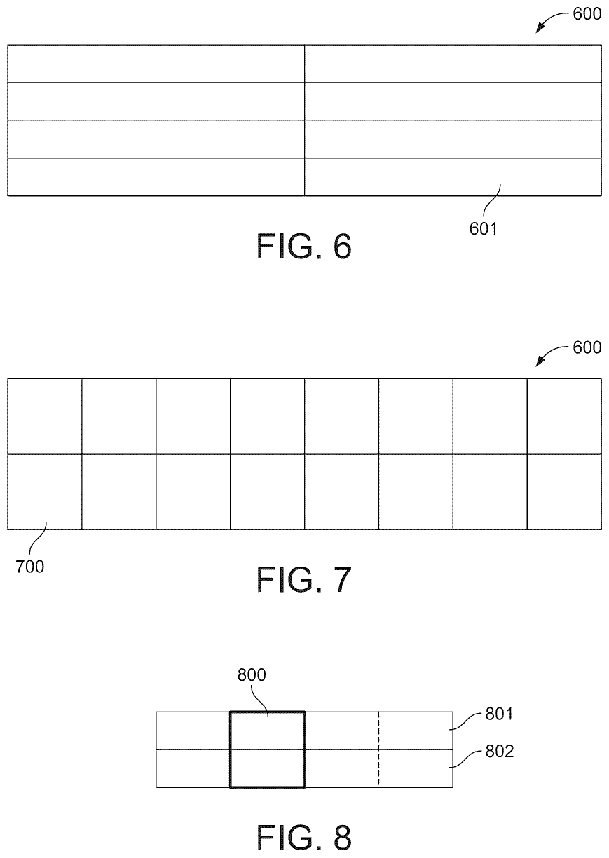

FIG. 6 illustrates this, and shows an exemplary output, such as a frame (image) 600 organised and stored in memory as a 2×4 array of 64×8 pixel (sampling position) compression units 601.

The compression unit size that the encoder 306 uses may be fixed, e.g. such that each different codec of the encoder 306 has its own, fixed compression unit size. Alternatively the encoder 306 may be operable to handle different sizes of input compression unit, for example with the particular size of compression unit to be used being set in use, for example on a (render) output-by-output basis.

As discussed above, in the present embodiments, the graphics processor 2 is a tile-based graphics processor, and thus operates to generate a given render output, such as a frame (an image), as respective tiles, which are typically square.

FIG. 7 illustrates this, and shows the corresponding tiles 700 that are generated when generating the frame (image) 600 shown in FIG. 6. It can be seen that the image 600 is generated as an array of 8×2 tiles, with each tile being 16x×6 pixels (sampling positions) in size (in this example).

It will be appreciated from FIGS. 6 and 7 that a given 16×16 rendering tile produced by the graphics processor will potentially cover only part of one or more of the compression units 601 that the encoder encodes for the output 600. FIG. 8 illustrates this, and shows an exemplary tile 800 forming only part of two respective compression units 801, 802.

As shown in FIG. 8, the compression units 801, 802 will in fact comprise respective parts from four of the rendering tiles that will be generated when rendering the output frame (image) 600. Thus in such cases, it will not be possible for the encoder simply to compress a rendering tile as and when that rendering tile is completed, as the rendering tile will not match the (size of) the compression unit that the encoder compresses.

The present embodiments address this issue of the tile size (potentially) not matching the compression block (compression unit) size that the encoder 306 requires for its encoding process in a tile-based graphics processor.

In particular, in the present embodiments, and in accordance with the technology described herein, and as shown in FIGS. 3 and 4, the graphics processor of the technology described herein includes an accumulation buffer 305 intermediate the tile write-out circuit 304 and the encoder 306, such that tiles will be written from the tile buffer 303 to the accumulation buffer 305, with the accumulation buffer then providing appropriate entire compression blocks (compression units) of tile data for compression to the encoder 306.

This then allows the encoder 306 simply to operate on and compress “complete” compression units, such that the encoder has no need, for example, to be able to perform partial compression of compression units, or to itself retrieve additional data for providing a “complete” compression unit for compression.

To facilitate this operation, the accumulation buffer 305 is configured to be able to store tile data from the tile buffer for plural compression units at the same time, so it can correspondingly accumulate tile data for plural compression units at the same time. The accumulation buffer 305 tracks the data that it is storing for all the compression units that it is currently storing, for example in the form of an appropriate compression unit tracking table.

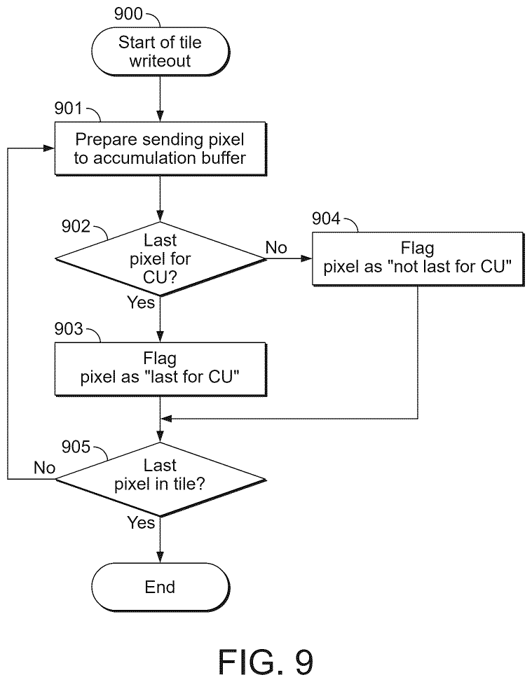

FIGS. 9-12 show the operation of the write-out circuit 304, accumulation buffer 305 and encoder 306 of a given shader core in embodiments of the technology described herein.

In the present embodiments, and as shown in FIG. 4, each shader core 400 has its own respective accumulation buffer 305 and encoder 306. Thus each shader core operates independently of the other shader cores in terms of the compression unit accumulation and encoding process.

Each shader core of the graphics processor (that has an accumulation buffer and encoder in the manner of the present embodiments) thus operates in the manner shown in FIGS. 9-12.

FIG. 9 shows the operation of the write-out unit (circuit) 304 when writing a finished tile out from the tile buffer 303.

When a tile is ready to be written from the tile buffer to the accumulation buffer 305 by the writeback unit 304 (step 900), the writeback unit indicates to the accumulation buffer which compression unit(s) the pixels (sampling positions) of the tile relate to. The accumulation buffer determines whether it is already accumulating data for the indicated compression unit(s), and if so, then the write of the sampling positions (pixels) from the tile buffer to the accumulation buffer is allowed to proceed (step 901).

When the tile data relates to a new compression unit, appropriate accumulation buffer storage for that new compression unit is allocated, together with an entry in the compression unit tracking table, before the data is then written to the accumulation buffer (step 901). The storage allocated for the compression unit is based on how much data will be necessary for the compression unit, e.g. based on the pixel (sampling position) format for the output being generated and the appropriate compression parameters (e.g. block size).

When storage for the compression unit(s) that the tile relates to is or has been allocated, the write-out circuit will write respective pixels (sampling positions) for the tile being written out to the allocated storage of the accumulation buffer 305.

The write out unit 304 determines whether a given pixel being written out is the last pixel for a given compression unit that will be written out from the shader core in question (step 902). The write-out unit then correspondingly marks (flags) the pixel being written out as either being the last pixel for the compression unit in question that will be produced by the shader core (step 903) or not (step 904).

The write-out unit tracks and indicates when a pixel being written out for a tile is the last pixel for a given compression unit that will be generated by the shader core in question (as a given shader core of the graphics processor may only process some but not all of the tiles of the overall render output being generated (with other tiles being processed by other shader cores), such that a given individual shader core may not itself generate all the pixels required for a given compression unit of the overall render output being generated.)

Accordingly, the write-out unit 304 keeps track of when the shader core in question has generated the last pixel that it itself is going to generate for a compression unit for the render output in question, and when it writes out a pixel (sampling position) to the accumulation buffer, indicates that to the accumulation buffer 305 accordingly. The write-out circuit 304 also indicates which compression unit for the output being generated (that the tile being written out belongs to) that each pixel for the tile that is being written out relates to.

This process is repeated until all the pixels for the tile in question have been written out from the tile buffer 303 to the accumulation buffer 305 (step 905).

The next tile (once ready) can then be written out from the tile buffer 303 to the accumulation buffer 305, and so on.

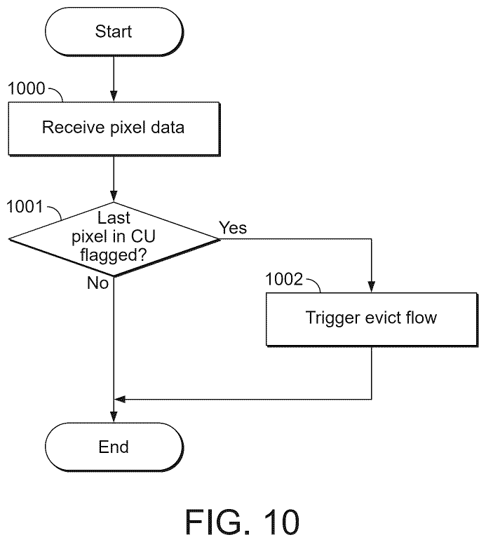

FIG. 10 shows the corresponding operation of the accumulation buffer 305 when receiving pixel data for a tile from the write-out unit 304. As shown in FIG. 10 the accumulation buffer 305 will receive pixel data written by the write-out unit 304 from the tile buffer 303, and add (store) that data to (for) the appropriate stored compression unit that it is accumulating (buffering). The tracking of the data stored for the compression unit will correspondingly be updated (step 1000).

As shown in FIG. 10, the accumulation buffer 305 also checks whether a pixel it receives has been flagged as being the last pixel in a compression unit (for the shader core in question, as discussed above) (step 1001).

When the last pixel for a given compression unit to be generated by a given shader core for a given render output is received by the accumulation buffer, then an appropriate eviction process to output the corresponding encoded compression unit is triggered (step 1002).

Otherwise, the process simply repeats as more pixel data is received.

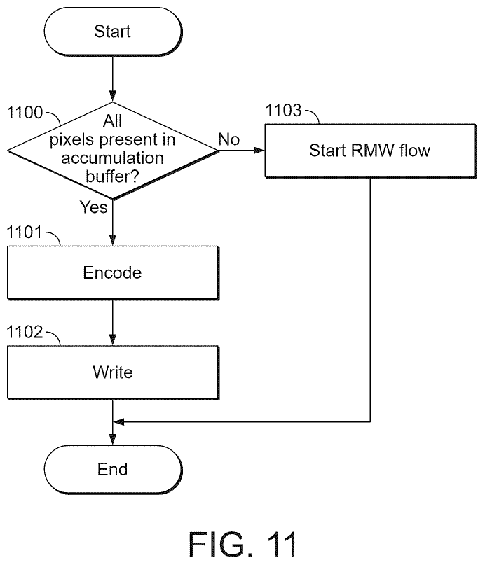

FIG. 11 shows the compression unit “eviction process” that is triggered in step 1002 in FIG. 10 when the last pixel for a compression unit that will be generated by the shader core in question is received by the accumulation buffer 305.

As shown in FIG. 11, the eviction process first determines whether all the pixels for the compression unit in question are present in the accumulation buffer (step 1100). This is determined from the compression unit tracking performed by the accumulation buffer.

If so, then the pixels for the compression unit are sent from the accumulation buffer 305 to the encoder 306, which operates to encode (compress) the compression unit (step 1101) and then write the compressed block of data to the memory system (step 1102).

On the other hand, and as shown in FIG. 11, when it is determined that not all pixels for the compression unit are present in the accumulation buffer (for the shader core in question), a “read-modify-write” flow is performed (step 1103) to enable the encoder 306 to still be provided with a “complete” compression unit for compressing.

In particular, as part of the read-modify-write flow, the accumulation buffer retrieves any “missing” data that it doesn't already store for the compression unit that is to be evicted from the memory system 6, to then be able to provide a complete compression unit to the encoder 306 for processing.

To do this, in the present embodiments, as shown in FIGS. 3 and 4, the accumulation buffer 305 sends an appropriate request to the texture mapper (texture unit) 307, which then operates to retrieve the requested “missing” data from the memory and return it to the accumulation buffer.

Once the accumulation buffer 305 has all the data for the complete compression unit, then it outputs the complete compression unit to the encoder 306 (as discussed above), and the encoder 306 then encodes (compresses) the compression unit and writes it to the memory system accordingly.

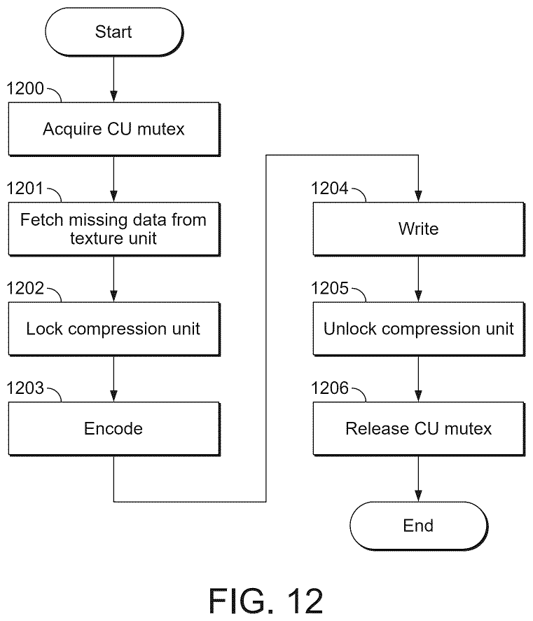

FIG. 12 shows the read-modify-write flow of step 1103 in FIG. 11 in more detail.

As shown in FIG. 12, at the start of this read-modify-write flow, the accumulation buffer 305 first acquires a (global) mutex for the compression unit in question (step 1200) (from the CU mutex handler 405). This is to ensure that only one accumulation buffer at any one time is performing a read-modify-write operation on a given compression unit for a render output. (As, discussed above, different shader cores of the graphics processor may be generating tiles for different parts of the same compression unit. It is therefore desirable to ensure that only one accumulation buffer has access to a compression unit for performing a read-modify-write operation at any one time.)

Once the compression unit mutex has been acquired, the accumulation buffer then signals the texture unit (texture mapper) 307 to fetch the data that it does not have for the compression unit in question (the “missing” compression unit data) from the memory system (step 1201).

The compression unit in question is then “locked”, so as to prevent all other texture mappers in the graphics processor from reading the data of the compression unit that is being encoded. This can be done in any appropriate and desired manner, and is in an embodiment achieved by invalidating any and all data related to the compression unit in question in all texture mappers in the GPU (such that they will not use any cached data for the compression unit in question).

In the present embodiments, this is done via the cache coherency protocol of the cache hierarchy for the graphics processor and graphics processing system in question. In an embodiment the accumulation buffer sends an appropriate “invalidation” request via the coherency protocol for this purpose.

In an embodiment, where compression units are stored as respective, separate, linked headers and payloads, then a compression unit is “locked” in this way by locking the header (the cache line storing the header) for the compression unit in question, such that that correspondingly causes invalidation of data related to the compression unit in all texture mappers in the graphics processor.

Once the texture unit has acquired the missing data from the memory system and provided it to the accumulation buffer 305, the accumulation buffer then provides the complete compression unit to the encoder 306 which then encodes the compression unit (step 1203) and writes the compression unit to the memory system (step 1204).

Once the compression unit has been written to the memory system, then the compression unit can be “unlocked”, so that texture mappers are able to read the compression unit (from the memory system) (step 1205). Again, this is in an embodiment achieved in the appropriate manner for the coherency protocol used in the graphics processor and graphics processing system in question, for example by writing an appropriate (valid) header to the memory system for the compression unit once the payload data for the compression unit has been written to the memory system.

The compression unit mutex is then released (step 1206).

Another accumulation buffer (shader core) can then perform a read-modify-write process for the compression unit, if required.

FIGS. 9-12 show the operation of the present embodiments in particular where data for compression units is accumulated in the accumulation buffer before being encoded and written to memory. This operation would be appropriate in the case where any given rendering tile does not provide a complete compression unit for encoding (i.e. where data from more than one rendering tile will be required for a compression unit).

The Applicants have further recognised that there could be situations where data from a single rendering tile provides a complete compression unit for encoding. This could be the case, for example, where the rendering tiles are equal to or larger than the compression units that the block-based encoding uses.

In this case, while it would still be possible simply to accumulate compression unit data in storage of the accumulation buffer and then output the compression units, e.g. “immediately”, in an embodiment, rather than storing the tile data in the accumulation buffer and then providing it from the accumulation buffer storage to the encoder, the tile data is instead streamed directly to the encoder as it is written out from the tile buffer. This may be via a communications path that bypasses the accumulation buffer entirely, or there may, for example, be a communication path that allows tile data to pass through the accumulation buffer without being (temporarily) stored in the storage of the accumulation buffer. In this case, the accumulation buffer will not accumulate any data for the tile, but rather the tile data will be passed directly to the encoder without being accumulated by the accumulation buffer.

It can be seen from the above, that the technology described herein, in its embodiments at least, facilitates improved block-based encoding arrangements in tile-based graphics processing. This is achieved, in the embodiments of the technology described herein at least, by using an accumulation buffer to accumulate data from tiles being generated by the graphics processor to provide complete compression units (compression blocks) to the block-based encoding process.

The foregoing detailed description has been presented for the purposes of illustration and description. It is not intended to be exhaustive or to limit the technology to the precise form disclosed. Many modifications and variations are possible in the light of the above teaching. The described embodiments were chosen in order to best explain the principles of the technology and its practical application, to thereby enable others skilled in the art to best utilise the technology in various embodiments and with various modifications as are suited to the particular use contemplated. It is intended that the scope be defined by the claims appended hereto.

1. A graphics processing system comprising:
a graphics processor;
wherein the graphics processor comprises:
processing circuits configured to execute a tile-based graphics processing pipeline to generate tiles of an output being generated;
a tile buffer for storing tiles of an output being generated; and
a write-out circuit for writing tiles of an output from the tile buffer towards a memory system;
the graphics processing system further comprising:
a data encoder configured to perform block-based compression of uncompressed tile data to be written from the tile buffer; and
an accumulation buffer intermediate the tile write-out circuit and the encoder;
wherein:
the tile write-out circuit is configured to provide tile data from the tile buffer to the accumulation buffer; and
the accumulation buffer is configured to provide tile data to the data encoder for encoding; and
the data encoder is configured to encode compression units of uncompressed data having a particular size for storing in a compressed format; and
the accumulation buffer is configured to provide arrays of data that are equal to the particular size to the data encoder for encoding.

2. The system of claim 1, wherein the data encoder and the accumulation buffer are part of the graphics processor.

3. The system of claim 1, wherein the graphics processor comprises a plurality of processing cores, with each processing core comprising a tile buffer, a write-out circuit, an accumulation buffer and a data encoder.

4. The system of claim 1, wherein the write-out circuit is configured to, when providing tile data from the tile buffer to the accumulation buffer, indicate to the accumulation buffer:
which compression unit for the render output being generated the tile data relates to; and/or
the tile data is the last tile data that will be provided from the tile buffer to the accumulation buffer for a compression unit.

5. The system of claim 1, wherein the accumulation buffer is configured to:
maintain a record of the compression units that it is currently storing data for, and keep track of what data the accumulation buffer currently stores for a compression unit.

6. The system of claim 1, wherein the providing of tile data for a compression unit from the accumulation buffer to the encoder is triggered in response to an indication that the tile data is the last tile data that will be provided from the tile buffer to the accumulation buffer for the compression unit.

7. The system of claim 1, wherein the accumulation buffer is configured to, for a compression unit for which the providing of tile data to the encoder has been triggered:
determine whether the accumulation buffer stores all of the data for the compression unit; and
when the accumulation buffer stores all of the data for the compression unit, provide the complete compression unit to the data encoder for encoding;
when the accumulation buffer does not store all of the data for the compression unit:
request the data for the compression unit that the accumulation buffer does not store from a memory system, and when all of the required data is returned from the memory system, combine that returned data with the already stored data for the compression unit so as to provide a complete version of the compression unit to the data encoder for encoding.

8. The system of claim 1, wherein the graphics processing system is configured and operable such that only one accumulation buffer can request data that the accumulation buffer does not store from a memory system for a given compression unit at any one time.

9. The system claim 1, wherein the system is configured to, when a tile to be output from the tile buffer has a data size greater than the particular compression unit data size:
provide the tile data directly to the encoder for encoding without the tile data being accumulated by the accumulation buffer.

10. An apparatus for encoding tile data to be written to a memory system from a tile-based graphics processor, the apparatus comprising:
a data encoder configured to perform block-based compression of uncompressed tile data to be written to a memory system; and
an accumulation buffer associated with the encoder;
wherein:
the accumulation buffer is configured to receive tile data to be written to a memory system and to provide tile data to be written to a memory system to the data encoder for encoding;
the data encoder is configured to encode compression units of uncompressed data having a particular size for storing in a compressed format; and
the accumulation buffer is configured to provide arrays of data that are equal to the particular size to the data encoder for encoding.

11. A method of operating a graphics processing system, the graphics processing system comprising:
a graphics processor operable to execute a tile-based graphics processing pipeline to generate tiles of an output being generated, the graphics processor comprising:
a tile buffer for storing tiles of an output being generated; and
a write-out circuit for writing tiles of an output from the tile buffer towards a memory system;
the graphics processing system further comprising:
a data encoder configured to perform block-based compression of uncompressed tile data to be written from the tile buffer to the memory system, the data encoder configured to encode compression units of uncompressed data having a particular size for storing in a compressed format; and
an accumulation buffer intermediate the tile write-out circuit and the data encoder;
the method comprising:
the tile write-out circuit providing tile data from the tile buffer to the accumulation buffer;
the accumulation buffer providing an array of tile data that is equal to the particular size to the data encoder for encoding; and
the data encoder compressing the array of tile data that is equal to the particular size provided by the accumulation buffer to generate a compressed block of tile data, and writing the compressed block of tile data towards a memory system.

12. The method of claim 11, wherein the data encoder and the accumulation buffer are part of the graphics processor.

13. The method of claim 11, wherein the graphics processor comprises a plurality of processing cores, with each processing core comprising a tile buffer, a write-out circuit, an accumulation buffer and a data encoder.

14. The method of claim 11, comprising the write-out circuit, when providing tile data from the tile buffer to the accumulation buffer, indicating to the accumulation buffer:
which compression unit for the render output being generated the tile data relates to; and/or
the tile data is the last tile data that will be provided from the tile buffer to the accumulation buffer for a compression unit.

15. The method of claim 11, comprising:
maintaining a record of the compression units that the accumulation buffer is currently storing data for, and keeping track of what data the accumulation buffer currently stores for a compression unit.

16. The method of claim 11, wherein the providing of tile data for a compression unit from the accumulation buffer to the encoder is triggered in response to an indication that the tile data is the last tile data that will be provided from the tile buffer to the accumulation buffer for the compression unit.

17. The method of claim 11, comprising, for a compression unit for which the providing of tile data to the encoder has been triggered:
determining whether the accumulation buffer stores all of the data for the compression unit; and
when the accumulation buffer stores all of the data for the compression unit, providing the complete compression unit to the data encoder for encoding;
when the accumulation buffer does not store all of the data for the compression unit:
requesting the data for the compression unit that the accumulation buffer does not store from a memory system, and when all of the required data is returned to the accumulation buffer from the memory system, combining that returned data with the already stored data for the compression unit so as to provide a complete version of the compression unit to the data encoder for encoding.

18. The method of claim 11, comprising permitting only one accumulation buffer to request data that the accumulation buffer does not store from a memory system for a given compression unit at any one time.)

19. The method of any one of claim 11, comprising, when a tile to be output from the tile buffer has a data size greater than the particular compression unit data size:
providing the tile data directly to the encoder for encoding without the tile data being accumulated by the accumulation buffer.

20. A non-transitory computer readable storage medium storing computer software code which when executing on one or more processors performs a method of operating an apparatus for encoding data to be written to a memory system, the apparatus comprising:
a data encoder configured to perform block-based compression of uncompressed data to be written to a memory system, the data encoder configured to encode compression units of uncompressed data having a particular size for storing in a compressed format; and
an accumulation buffer associated with the encoder;
the method comprising:
the accumulation buffer receiving data to be written to a memory system and providing an array of data that is equal to the particular size to the data encoder for encoding; and
the data encoder compressing the array of data that is equal to the particular size provided by the accumulation buffer to generate a compressed block of data, and writing the compressed block of data towards a memory system.
